(19) United States
(12) Patent Application Publication
(10) Pub. No.: US 2006/0028527 A1
(43) Pub. Date: Feb. 9, 2006

(54) Inkjet recording medium

(75) Inventors: Makoto Kaga, Tokyo (JP); Masayoshi Yamauchi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 11/186,692

(22) Filed: Jul. 21, 2005

(30) Foreign Application Priority Data
Aug. 5, 2004 (JP) JP2004-229162
Mar. 25, 2005 (JP) JP2005-088141
Mar. 28, 2005 (JP) JP2005-090826

(51) Int. Cl. B41J 2/01

(52) U.S. Cl. 347/105

(57) ABSTRACT

An inkjet recording medium comprising a support having thereon an interlayer and an ink-absorbing layer in that order, wherein: a C value of the support is not less than 50, the C value being a scale of image clarity; a 60° specular glossiness of the support is not less than 20%; and a moisture permeability of the support after the interlayer is provided is no less than 100 g/m²/day and not more than 5000 g/m²day.

This application is based on Japanese Patent Applications No. 2004-229162 filed on Aug. 5, 2004, No. 2005-88141 filed on Mar. 25, 2005 and No. 2005-090826 filed on Mar. 28, 2005 in Japanese Patent Office, the entire content of which is hereby incorporated by reference.

### FEILD OF THE INVENTION

The present invention relates to an inkjet recording medium and a production method thereof, and specifically to an inkjet recording medium which has been improved in glossiness, paper tracking, prevention of curl before and after printing, bleeding resistance after printing, ink absorbability and crack resistance, and to a producing method thereof.

### BACKGROUND OF THE INVENTION

In recent years, an inkjet recording method has been rapidly improved in image quality, which is approaching to image quality of silver halide photography. To satisfy photographic image quality, various conditions are required. One of the most important characteristics among them is gloss. There are generally two types of manufacturing methods of a glossy inkjet medium. One method is to utilize a non-water absorptive support (hereinafter, being also referred to as resin coated (RC) paper) containing a paper base material utilized in the above silver photography the both surface of which has been coated with such as olefin resin. The other method is called as one for cast coated paper, in which absorptive support is utilized and an ink-absorbing layer and a gloss providing layer are applied on said support, followed by being dried while keeping the smoothness by pressing the wet coated material onto a mirror surface drum, which has been heated and smoothened.

An inkjet recording medium employing resin coated paper is classified as a high quality glossy inkjet recording medium since smoothness of the support is high to maintain the high smoothness even after an ink-absorbing layer having been coated. However, since resin coated paper support itself is not provided with water absorbability and ink absorption has to be met by only an ink-absorbing layer, ink-absorbing layer has to be coated thick. Therefore, in an inkjet recording medium which is not printed, ink-absorbing layer may suffer from a phenomenon of causing cracks by being applied with stress such as crease and bend. Further, a manufacturing process of resin coated paper, to make the support water non-absorptive, is extremely complex, resulting in causing increase of cost of a support. Further, to make water non-absorptive, the both side surfaces of the center stock having been made into paper are coated with polyolefin resin by a fusing extrusion method, resulting in a form of a complex material. Therefore, there is a problem of an environmental adaptability that the recording medium cannot be burned to be scrapped.

On the other hand, since cast coated paper for inkjet application utilizes a water absorptive support, ink absorption can be met by the both of an ink-absorbing layer and a support and it is possible to make an ink-absorbing layer thinner and improve ink-absorbing rate. However, the support itself is inferior in smoothness as well as smoothness after coating of an ink-absorbing layer is low due to cracks caused at the time of drying by being pressing contacted to a cast drum, resulting in a problem of lack of gloss feeling compared to an inkjet recording medium employing resin coated paper.

As a technique to overcome the above-described problem of cast coated paper, for example, disclosed is a technique in which the upper limit of existing density of cracks generated on the surface of an inkjet recording medium is defined (refer to such as Patent Documents 1 and 2). However, at present, an inkjet recording medium employing these proposed cast coated paper is inferior in gloss feeling to an inkjet recording medium employing resin coated paper as a support. Further, since a water-absorptive support is utilized, there is a problem that ink components may penetrate paper support after printing to cause cockling.

On the other hand, as a substitute technique of the above-described resin coated paper, disclosed is a technique in which a covering layer containing hollow micro-particles on a paper support and further an ink-absorbing layer thereon are provided to promote compatibility of gloss and absorptive rate (for example, refer to Patent Document 3). However, an ink absorption volume, which permeates into paper substrate passing through a covering layer, increases contrary by utilizing hollow micro-particles, resulting in causing cockling and deteriorated gloss feeling.

Further, an index to show a penetration of an ink component into the paper support includes such as gas permeability and moisture permeability. Disclosed are techniques which intend to improve gloss by defining these values (refer to Patent Documents 4 and 5), however, any of these proposed methods is a techniques related to an inkjet recording medium by a cast coating method, there is no description on improvement of cockling of a print after having been printed, in addition that these methods, at present, cannot be said satisfactory as a techniques with respect to improvement of glossiness.

As the results of further considerations on the above problems, an inkjet recording medium prepared as described below was found to achieve improvement in both (i) resistance for high-humidity bleeding after printing, and (ii) glossiness, namely, the inkjet recording medium is prepared by providing a interlayer having a function to prevent permeation of water on a high-flatness and highly absorptive support, followed by providing an ink-absorbing layer on the interlayer. However, it was found that the inkjet recording medium still has problems in anti-curl property and in paper tracking.

Further, disclosed is a inkjet recording medium prepared by applying a water dispersive polymer on a highly absorptive support, followed by a calendar treatment at above glass-transition temperature (Tg) of the polymer (for example, refer to Patent Document 3). In this method, by applying a temperature high than Tg, the water dispersive polymer is effectively melted, however, the surface of the calendar drum may be contaminated or flatness of a support may be lost due to transfer of polymer to the surface of the calendar drum.

(Patent Document 1) JP-A No. 11-348416 (Hereinafter, JP-A refers to Japanese Patent Publication Open to Public Inspection.)

(Patent Document 2) JP-A No. 2001-287442

(Patent Document 3) JP-A No. 2002-59637

(Patent Document 4) JP-A No. 8-246392

(Patent Document 5) JP-A No. 2000-238406

(Patent Document 6) JP-A No. 2004-347722

### SUMMARY OF THE INVENTION

An object of the present invention is to provide an inkjet recording medium which has been improved in glossiness, paper tracking, prevention of curl before and after printing, bleeding resistance after printing, ink absorbability and crack resistance, and to provide a producing method thereof.

One of the aspects of the present invention is an inkjet recording medium containing a support having thereon an interlayer and an ink-absorbing layer in that order, wherein: a C value of the support is not less than 50, the C value being a scale of image clarity; a 60° specular glossiness of the support is not less than 20%; and a moisture permeability of the support after the interlayer is provided is not less than 100 g/m²/day and not more than 5000 g/m²/day.

### DESCRIPTION OF THE PREFERRED EMBODIMENTS

The above object of the present invention is achieved by the following structures.
(1) An inkjet recording medium containing a support having thereon an interlayer and an ink-absorbing layer in that order, wherein:

a C value of the support is not less than 50, the C value being a scale of image clarity;

a 60° specular glossiness of the support is not less than 20%; and

a moisture permeability of the support after the interlayer is provided is not less than 100 g/m²/day and not more than 5000 g/m²/day.
(2) The inkjet recording medium of Item (1), wherein a surface roughness of the support provided with the interlayer is not less than 0.05 μm and not more than 0.2 μm, measured at a cut-off value of 0.8 mm with a standard length of 4 mm.
(3) The inkjet recording medium of Item (1) or Item (2), wherein a moisture permeability of the support is not less than 7000 g/m²/day and not more than 12000 g/m²/day.
(4) The inkjet recording medium of any one of Items (1) to (3), wherein the support comprises a cast-coated paper.
(5) The inkjet recording medium of any one of Items (1) to (4), wherein the interlayer contains an acryl resin emulsion.
(6) The inkjet recording medium of any one of Items (1) to (5), wherein the ink-absorbing layer contains inorganic microparticles and a hydrophilic binder.
(7) The inkjet recording medium of Item (6), wherein the hydrophilic binder contains a polymer prepared by irradiating a hydrophilic polymer containing a main chain and a plurality of side chains with ionizing radiation so as to form cross-linking bonds between the side chains.
(8) An inkjet recording medium containing a support having thereon an interlayer and an ink-absorbing layer in that order on one surface of the support and having a resin layer on the other surface of the support opposite the interlayer, wherein

a moisture permeability of the support provided with the interlayer and the resin layer is not less than 100 g/m²/day and not more than 5000 g/m²/day; and

a surface roughness Ra of a surface of the support provided with the interlayer is not less than 0.05 μm and not more than 0.2 μm, measured at a cut-off value of 0.8 mm with a standard length of 4 mm.
(9) The inkjet recording medium of Item (8), wherein

the support comprises a cast-coated paper; and

the interlayer and the resin layer are waterproof layers.
(10) The inkjet recording medium of Item (9), wherein

the interlayer and the resin layer are waterproof layers having substantially the same composition; and

a weight ratio of a solid portion contained in the interlayer to a solid portion contained in the resin layer is in the range of 0.05:1to 0.50:1.
(11) The inkjet recording medium of Item (10), wherein

the interlayer or the resin layer contains an acryl resin as a main component.
(12) The inkjet recording medium of Item (10) or Item (11), wherein

the interlayer or the resin layer contains a surfactant.
(13) The inkjet recording medium of any one of Items (10) to (12), wherein

the interlayer or the resin layer contains an antifoam agent.
(14) The inkjet recording medium of any one of Items (10) to (13), wherein

the interlayer or the resin layer contains a film-forming auxiliary agent.
(15) The inkjet recording medium of any one of Items (10) to (14), wherein

an additional layer is provided between the interlayer and the ink-absorbing layer.
(16) A method for producing the inkjet recording medium of any one of Items (1) to (15) containing the steps of:

providing the interlayer on the support;

modifying a surface of the interlayer; and

providing the ink-absorbing layer on the modified interlayer.
(17) The method of Item (16), wherein the step of modifying the surface of the interlayer and the step of providing the ink-absorbing layer are carried out in an on-line system.

The present invention provides an inkjet recording medium which has been improved in glossiness, paper tracking, prevention of curl before and after printing, bleeding resistance after printing, ink absorbability and crack resistance, and to a producing method thereof.

In the following, the most preferable embodiment of the present invention will be detailed.

It was found that an inkjet recording medium which has been improved in glossiness, bleeding resistance after printing, ink absorbability and crack resistance can be realized by an inkjet recording medium which is provided with at least one ink-absorbtion layer on a support, wherein (i) said support has a C value of not less than 50 and a specular glossiness of the support measured at 60° of not less than 20%, (ii) an interlayer is provided between the support and the ink-absorbtion layer and moisture permeability of the support after the interlayer is provided is not less than 100 g/m²/day (g/m² per day)and not more than 5000 g/m²/day.

In the following, an inkjet recording medium of the present invention will be explained.

An inkjet recording medium (hereinafter, referred to as simply a recording medium) of the present invention is characterized in that an interlayer is provided on a support having a C value of not less than 50 and a 60° specular glossiness of not less than 20%, and moisture permeability of the support after the interlayer is provided is not less than 100 g/m²/day and not more than 5000 g/m²/day.

First, a support utilized in a recording medium of the present invention will be explained.

In the present invention, a commonly known support, which is applied for a commonly known inkjet recording medium, can be utilized; however a water absorptive support is preferred.

Supports according to the present invention include water absorptive paper supports such as art paper, coated paper and cast coated paper.

Paper utilized for a support according to the present invention is made into paper employing wood pulp as a primary raw material appropriately added with synthetic pulp such as polypropylene or synthetic fiber such as Nylon or polyester in addition to wood pulp. As wood pulp, any of LBKP, LBSP, NBKP, NBSP, LDP, NDP, LUKP and NUKP can be utilized, however, it is preferable to utilize more of LBKP, NBSP, LBSP, NDP or LDP, which is richer in short fiber. Herein, a ratio of LBSP and/or LDP is preferably 10-70%. As the above pulp, chemical pulp containing few impurities is preferably utilized, and pulp having been subjected to a bleach process to improve whiteness is also useful.

In paper, can be appropriately added a sizing agent such as higher fatty acid, an alkyl ketene dimmer; a white pigment such as calcium carbonate, talc and titanium oxide; a paper strength enhancing agent such as starch, polyacrylamide and polyvinyl alcohol; a fluorescent whitening agent; a moisture retaining agent such as polyethylene glycol; a dispersant and a softening agent such as quaternary ammonium.

Freeness of pulp utilized in paper making is preferably 200-500 ml based on the definition of CSF, and fiber length after beating is preferably 30-70% as the sum of a 24 mesh residue and a 42 mesh residue defined in JIS P 8.207. Herein, a 4 mesh residue is preferably not more than 20%.

Basis weight of paper is preferably 50-250 g and specifically preferably 70-200 g. Thickness of paper is preferably 50-210 μm.

Paper may be provided with a high smoothness by being subjected to a calendar treatment during or after paper making. Paper density is generally 0.7-1.2 g/cm² (JIS P 8118). Further, raw paper stiffness is preferably 20-200 g based on the definition of JIS P 8143.

A surface sizing agent may be coated on the paper surface, and surface sizing agents similar to those can be added in the aforesaid raw paper can be utilized.

pH of paper is preferably pH 5-9 when being measured by a hot water extraction method defined by JIS P 8113.

In a recording medium of the present invention, one of the characteristics is that a support to be applied has a C value of not less than 50 and a 60° specular glossiness of not less than 20%.

Generally as an index to show gloss of an image, a specular glossiness has been utilized; however, a specular glossiness represents a ratio of light regularly reflected against light incident from a certain degree. For example, even with a low surface smoothness, glossiness of a material provided with the surface having a high reflectivity of light is expressed higher. However, it does not necessarily correspond to a so-called gloss feeling which can be felt by human eyes.

Therefore, in the present invention, employed is a scale of image clarity called as a C value as an index to judge glossiness. The C value referred to in the present invention is a value measured by a reflection method employing a 2 mm optical comb (which is a transparent tape having dark stripes being impenetrable to light in every 2 mm) among the image clarity evaluating methods defined in JIS K 7105, and can be determined by use of such as Image Clarity Meter ICM-IDP (manufactured by Suga Test Machine Co., Ltd.). In this method, the intensity of light reflected by an image to be evaluated is measured by a detector while a 2 mm optical comb is moving in the light path of the reflected light. The maximum intensity: Iₘₐₓ and the minimum intensity: Iₘᵢₙ measured by the detector while the optical comb is moving are used to determine the C value according to the following equation:
(Cvalue)=(Iₘₐₓ−Iₘᵢₙ)/(Iₘₐₓ+Iₘᵢₙ)

Further, image clarity expresses a capability of the film surface to reflect an image of an object facing to the film surface, and a value to show how accurately an incident image is reflected or projected on an image surface. The more accurate is a reflective image against an incident image, the higher is image clarity resulting in a larger C value. This C value represents a combined effect of a specular glossiness and surface smoothness, and the larger becomes a C value when the higher is reflectivity or the higher is smoothness.

A C value of a material such as wood free paper having distinctly lower gloss feeling is high irrespective to low visual gloss feeling, therefore, evaluation from both aspects of a C value and glossiness is preferable for correct interpretation of gloss.

A 60° specular glossiness according to the present invention is a value (%) measured by the measurement method described in JIS Z 8741 which corresponds to ISO 2813:94, 7688:86. An apparatus employed for the measurement of the 60° specular glossiness according to the present invention includes, for example, Precision Gloss Meter GM-26D, True Gross GM-26DPRO and Variable Degree Gloss Meter GM-3D (these are all manufactured by Murakami Color Technical Laboratory), VG-2000 (manufactured by Nippon Denshoku Industry Co., Ltd.) and Digital Variable Degree Gloss Meter (manufactured by Suga Test Machine Co., Ltd.).

In a support according to the present invention, there are specifically no limitations as a means to achieve a C value of not less than 50, however, a desired C value can be realized by coating a coating solution essentially containing inorganic pigment such as kaolin, clay and calcium carbonate and a binder such as synthetic latex, starch and casein as primary components on base paper, which is press contacted to a heated drum having been mirror processed while being in a wet state, and by being dried to be a product; the example includes high glossy printing paper such as cast coated paper for printing.

A recording medium of the present invention is characterized in that an interlayer is provided between a support having characteristics defined above and an ink-absorbing layer containing inorganic micro-particles described later.

An interlayer according to the present invention is a functional layer to restrain cockling of a support by controlling permeability of water, which is contained in an ink-absorbing layer coating solution, into a water absorptive support at the time of coating, in addition to maintaining smoothness of the support. However, bleeding resistance under a high humidity environment may be deteriorated when water permeability is completely inhibited, therefore it is a key point to set optimum moisture permeability to balance smoothness and bleeding resistance in the state of a support and an interlayer having been provided.

Materials applicable in an interlayer according to the present invention are required to be provided with capability of decreasing moisture permeability, and for example, when moisture permeability is too low, water and other organic solvent components in ink become unable to permeate into a support resulting in increase of bleeding during high humid storage after printing. Further, on the contrary, when moisture permeability is too high, water in the ink-absorbing layer coating solution, which is coated on the interlayer, permeates excessively into a support to cause cockling, resulting in decrease of smoothness of the ink-absorbing layer and accordingly decrease of gloss feeling.

According to the study of the inventors of the present invention, effects of the present invention can be obtained owing to a gloss property of a support and the presence of an interlayer, however, moisture permeability, measured in the state of a support and an interlayer having been provided, is adjusted to preferably not less than 100 g/m²·day and not more than 5000 g/m²·day and more preferably not less than 1000 g/m²·day and not more than 4000 g/m²·day, with respect to obtaining still higher aimed effects.

In an inkjet recording medium of the present invention, moisture permeability in the presence of a support and an interlayer is a value (g/m²·day) measured according to a method described in JIS Z 0208 and under a condition of 40° C. and 90% RH.

The thickness of an interlayer according to the present invention is preferably not less than 1 μm and not more than 30 μm. When the thickness of an interlayer is less than 1 μm, the function of an interlayer is insufficient to control moisture permeability, while, when it is over 30 μm, the smoothness is decreased resulting in decrease of gloss feeling after coating of an ink-absorbing layer.

In an inkjet recording medium of the present invention, the surface roughness in a state of an intermediate layer having been coated on a support, is preferably not less than 0.05 μm and not more than 0.2 μn, as surface roughness at a cut off value of 0.8 mm and a standard length of 4 mm. In the case of a surface roughness of less than 0.05 μm, it is not preferable because of too strong glossy feeling to cause significant glare. While, in the case of a surface roughness of over 0.2 μm, it is not preferable because of a large decrease of glossy feeling.

Surface roughness (also referred to as center-line mean roughness) referred in the present invention is represented by center-line mean roughness measured at a standard length of 4.0 mm and a cut off value of 0.8 mm based on the method defined by JIS-B-0601.

As a specific measuring method of mean roughness, after samples to be measured are rehumidified under an environment of 25° C. and 65% RH for 24 hours in a condition without piling up the samples each other, measurement is carried out under the same environment. Measurement apparatus to be utilized include, for example, Surfcom 500B, manufactured by Tokyo Precision Co., Ltd.

Materials utilized as an intermediate layer according to the present invention include, for example, water-dispersible polymer of such as polycarbonate, polyacrylonitrile, polystyrene, polyurethane, polyethylene, polypropyrene, polyacrylic acid, polymethacrylic acid, polyvinyl chloride, polyvinylidene chloride, polyvinyl acetate, polyester, polyamide, polyether, polybutadiene or copolymers thereof. Among them, acrylic ester and styrene-acryl copolymer are preferable with respect to gloss characteristics and moisture permeation control. Since water-dispersible polymer contains resin provided with a high solid content and a low viscosity, there are advantages with respect to gloss characteristics and drying behavior, while the polymer often shows specific fluid behavior such as thixotropic characteristics. To improve this point, water-dispersible polymer of a core-shell type, which contains a hydrophilic shell portion and a hydrophobic core portion, may be utilized.

On the other hand, when water-soluble polymer such as polyvinyl alcohol, gelatin and polyethylene oxide is utilized as an intermediate layer followed by coating an ink-absorbing layer, a material of an intermediate layer is dissolved again by water content in an ink-absorbing layer coating solution, resulting in inducing permeation of water content of a coating solution into a support; which is not preferable.

Binders utilized in an interlayer include such as the following water dispersible polymer.

Water dispersible polymer utilized in an interlayer according to the present invention is preferably one provided with a glass transition temperature (Tg) of 0-80° C. so as to enable fusing film formation in a coating•drying process. When the glass transition temperature is lower than 0° C., film formation excessively proceeds after coating•drying to shield permeation of ink solvent components by the interlayer resulting in no improvement of bleeding resistance under high humidity. While, the Tg is higher than 100° C., fusing film formation of water dispersible polymer becomes insufficient to cause permeation of the water component in an ink receiving layer coating solution into a paper support or decrease of gloss feeling due to decrease of smoothness, which is not preferable.

Further, the particle diameter of water dispersible polymer is preferably not less than 0.1 μm and not more than 0.5 μm. In the case of less than 0.1 μm, fusing film formation excessively proceeds to restrain permeation of ink solvent components into a paper support, while in the case of over 0.5 μm, gloss feeling is decreased due to a similar reason to the case of glass transition temperature.

Generally, these water dispersible polymers are prepared by an emulsion polymerization method. Those utilized in an ordinary method may be applied as for a surfactant and a polymerization initiator employed therein. A synthesis method of water dispersible polymer is detailed in such as U.S. Pat. Nos. 2,852,368, 2,853,457, 3,411,911, 3,411,912 and 4,197,127; Belgian Patent Nos. 688,882, 619,360 and 712,823; Examined Japanese Patent Application Publication No. 45-5331; JP-A Nos. 60-18540, 51-130217, 58-137831 and 55-50240.

In an inkjet recording medium of the present invention, to improve chromaticity of a white background, colored pigment, dye and a fluorescent whitening agent may be utilized in a coating solution of an intermediate layer, an ink-absorbing layer or an ink-absorbing layer.

An intermediate layer according to the present invention can be coated by various types of apparatus such as a blade coater, a roll coater, an air-knife coater, a bar coater, a rod coater, a gate roll coater, a curtain coater, a short dwell coater, a graveure coater, a flexo-graveure coater and a size press, in an on-machine or off-machine mode. Further, after coating, an intermediate layer may be finished by use of a calendar such as a machine calendar, a thermal calendar and a soft calendar.

Water-dispersible polymer utilized in an intermediate layer according to the present invention is preferably provided with a glass transition point (Tg) of −20-80° C. so as to enables fusing film formation during coating and drying processes. In the case of a glass transition point of lower than −20° C., film formation excessively proceeds after coating and drying to make an intermediate layer interrupt permeation of an ink solvent component, resulting in no improvement of bleeding under high humidity. While, in the case of a Tg of higher than 80° C., fusing film formation of water-dispersible polymer becomes insufficient to cause permeation of water content of an ink receiving layer coating solution into a support and decrease of glossy feeling due to decrease of smoothness; which is not preferable.

Next, a back surface resin layer, which is provided on the surface opposite to an intermediate layer sandwiching a support, will be explained.

As a material utilized to form a back surface resin layer according to the present invention, the materials similar to those described in the above explanation of an intermediate layer can be utilized, further the same type materials as those utilized to form an intermediate layer being preferable with respect to curl characteristics, and it is important that the material is capable of controlling a water permeation ratio.

Since gloss characteristics and smoothness of the back surface are not regarded as specifically important, there are no desirable ranges with respect to these physical properties.

However, a ratio of amounts of materials coated on the front surface and the back surface of a recording medium is important in order to control the amount of water permeating each resin layer formed on both surfaces. Herein, a front surface designates a surface of a recording medium on which an ink-absorbing layer is formed and a back surface designates a surface of the recording medium opposite to the front surface.

With respect to improving curl characteristics, a weight ratio of a solid portion contained in the intermediate layer on the front surface to a solid portion contained in a resin layer coated on the back surface is preferably in the range of 0.05:1 to 0.50:1. In the case of a weight ratio of less than 0.05:1, the intermediate layer solid amount provided on the front surface side becomes too small to increase water permeation amount from the front surface side compared to that from the back surface, and swelling of the ink-absorbing layer surface side becomes larger as a recording medium, resulting in generation of curling toward the back surface side, that is, so-called minus curling. On the contrary, in the case of a weight ratio of over 0.50:1, swelling of the ink-absorbing layer surface side becomes smaller as a recording medium, resulting in generation of curling of the back surface side toward the ink-absorbing layer side, that is, so-called plus curling.

In a recording medium of the present invention, a weight ratio of a solid portion contained in the interlayer to a solid portion contained in the resin layer is preferably in the range of 0.05:1 to 0.50:1, which is a design of relatively small as a solid amount. This is because a support utilized in the present invention has a higher moisture absorbability from the back surface compared to from the front surface, and a resin coating amount on a back surface becomes large. The more preferable range of the weight ratio to achieve an effect of the present invention is 0.10:1 to 0.30:1.

Coating layer thickness of an intermediate layer or a back surface resin layer as a water resistant layer according to the present invention is preferably in a range of 0.50-10 μm. In the case of a thickness of a water resistant layer of less than 0.50 μm, a water resistant capability is insufficient, and for example, when the water resistant layer is an intermediate layer, the surface gloss and smoothness after coating of an ink-absorbing layer will be decreased. On the other hand, in the case of a coated layer thickness of over 10 μm, smoothness and transparency of the coated layer of a water resistant layer will be decreased; which is not preferable. Generally, in resin coated paper having been utilized as photographic print paper, a coated amount of polyolefin, which exhibits a water resistant property, is approximately 20-30 g per 1 square meter with respect to the both of front and back surfaces. This is preferable to decrease a raw material cost and a manufacturing cost in manufacturing of a support according to the present invention.

A water resistant layer according to the present invention utilizes a material containing water-dispersible polymer as described above, however, said polymer, after having been coated on a support and dried, may be either left under room temperature or further dried by heating. The purpose of drying by heat is to accelerate fusing film formation of water-dispersible polymer having been coated. When utilized is a material having a minimum film forming temperature of extremely low such as not higher than 0° C., post-heating after drying is not necessary. Contrary, when a minimum film forming temperature is high, it is preferable to provide post-heating after drying to achieve an object of the present invention. The temperature can be arbitrary set depending on the minimum film forming temperature and the glass transition point of the material.

Further, an intermediate layer and a back surface resin layer, according to the present invention, utilize a material to control water content permeation into a support. In particular, in an intermediate layer provided on the front surface side, since an ink-absorbing layer is provided on an intermediate layer, improvement of a coating behavior of an intermediate layer coating solution itself on a support and improvement of a coating behavior of an ink-absorbing layer coating solution on an intermediate layer become important with respect to forming an ink-absorbing layer having excellent flatness. Further, a back surface resin layer which is provided on the back surface side also requires high flatness.

With respect to the above-described problems, in a recording medium of the present invention, to improve coating behavior of an intermediate layer coating solution or a back surface resin layer coating solution on a support to obtain a coated layer provide with high flatness, a surfactant is preferably incorporated in each coating solution.

Surfactants utilized in the present invention are not specifically limited, however, succinic acid type surfactants such as dipotassium alkenylsuccinate, sodium dialkylsulfosuccinate, sodium dioctylsulfosuccinate, fatty acid glycerylsuccinate and lauryl-2-sodium sulfosuccinate are preferably utilized.

Further, in a recording medium of the present invention, a defoaming agent is preferably added in each coating solution to restrain generation of air-bubbles in preparation, a coating process and a drying process, of an intermediate layer coating solution or a back surface resin layer coating solution, and to improve the coating behavior on a support and to obtain a coated layer having high flatness.

A function of a defoaming agent, when being detailed, is classified as follows.

Breaking of Bubbles:

Function to unify or break bubbles by immersion into a bubble from the air side against foam (aggregate of bubbles).

Depression of Bubbles:

Function to unify or break bubbles resulting in making foaming difficult, by immersion into a bubble from the liquid side.

Removal of Bubbles:

Function to unify bubbles to be risen to the surface by immersion into the interface of air-bubbles.

In the present invention, it is important to select a material provided with these functions in suitable balance, and preferable materials include a nonionic antifoam agent, an anionic antifoam agent and a silicone antifoam agent having a high solubility against each coating solution.

Further, water-dispersible polymer utilized in an intermediate layer or a back surface resin layer according to the present invention exhibit functions to control water permeation into a support, by fusing film formation after having been coated, and a film forming aid is preferably incorporated in the present invention to accelerate the fusing film formation.

As for an addition timing of a film forming aid, a film forming aid may be either added at the time of polymerization of the polymer or added in a coating solution containing water-dispersible polymer.

Film forming aids preferably utilized in the present invention include, for example, ethylene glycol, xylene, carbitol, hexylene glycol, cellosolve, dibutyl glycol phthalate, dibutyl phthalate, benzyl alcohol, diisopropyl succinate ester, butylcarbitol acetate, dibutyl phthalate, 2,2,4-trimethyl-1,3-pentanediol monoisobutylate, diethylene glycol monobutyl ether acetate, diethylene glycol monobuty ether acetate, ethylene glycol monobutyl ether, propylene glycol monomethyl ether acetate, diisopropyl glutarate and butylcarbitoi acetate.

Further, in an inkjet recording medium of the present invention, to provide an additional layer between an intermediate layer and an ink-absorbing layer is a preferable embodiment in view of improving coating behavior of an ink-absorbing layer.

The additional layer according to the present invention is primarily constituted of hydrophilic polymer, and utilized as hydrophilic polymer can be commonly known hydrophilic polymers such as gelatin or gelatin derivatives, polyvinyl alcohol or polyvinyl alcohol derivatives, polyvinyl pyrrolidone, polyethylene oxide, polyacrylamide, carboxymethyl cellulose, hydroxyethyl cellulose, starch and starch derivatives, colorgienan, gum arabi and pulullane. These hydrophilic polymers may be also utilized in combination of at least two types.

Furthermore preferable hydrophilic polymers are gelatin or gelatin derivatives, and polyvinyl alcohol and polyvinyl alcohol derivatives, and most preferable polymers are polyvinyl alcohol or polyvinyl alcohol derivatives.

In an additional layer, such as a hardener, a surfactant, a silane coupling agent, a titane coupling agent, a toning agent, a fluorescent whitening agent, a matting agent or a pH adjusting agent can be appropriately utilized.

In the case of hydrophilic polymer contained in an additional layer being gelatin or gelatin derivatives and polyvinyl alcohol and polyvinyl alcohol derivatives, cracking is further decreased by incorporating a hardener suitable for these polymers in said additional layer; which is a preferable embodiment. By providing these hardeners after coating of an additional layer and before coating of an ink-absorbing layer, the additional layer is hardened to be restrained to swell at the time of coating of the ink-absorbing layer. Therefore, shrinking stress of a hard porous layer is decreased at the time of drying of an ink-absorbing layer, resulting in bare generation of cracking.

In the case that hydrophilic polymer contained in an additional layer being gelatin or gelatin derivatives, as preferable hardeners, such as vinylsulfon type hardeners, acryloyl type hardeners, aldehyde type hardeners, epoxy type hardeners and active halogen type hardeners can be utilized. Further, in the case that hydrophilic polymer being polyvinyl alcohol or polyvinyl alcohol derivatives, as preferable hardeners, boron type hardeners such as boric acid and borax, and epoxy type hardeners can be utilized. These hardeners are utilized at approximately 0.001-0.5 g per 1 g of hydrophilic polymer.

In the above-described manner, an ink-absorbing layer is coated after an intermediate layer has been applied on a support, however, since an intermediate layer controls water permeation into a support, the coating behavior may be deteriorated in the case of an ink-absorbing layer coating solution is a water-based system. Therefore, a manufacturing method of an inkjet recording medium of the present invention is characterized in that the intermediate layer surface is subjected to a pre-treatment such as a flame treatment, a plasma treatment, a UV ozone treatment and a corona treatment, after application of the intermediate layer and before coating of an ink-absorbing layer. Further, to improve the productivity, in a manufacturing method of an inkjet recording medium of the present invention, the above-described surface treatment after coating of an intermediate layer and coating of an ink-absorbing layer are more preferably performed continuously (on line).

Next, an ink-absorbing layer according to the present invention will be explained.

An ink-absorbing layer is formed by using primarily a hydrophilic binder and inorganic micro-particles at a weight ratio in a rage of 2/1-20/1. Heretofore, various methods to form voids in a film layer have been known, and include, for example, a method in which a homogeneous coating solution containing at least two types of polymers is coated on a support and voids are formed by forcing these polymers to be phase separated each other during the drying process, a method in which a coating solution containing solid micro-particles and a hydrophilic binder or a hydrophobic binder on a support and voids are formed by immersing an inkjet recording medium in water or a suitable organic solvent to dissolve the solid micro-particles, a method in which a coating solution containing a compound provided with a property to foam at the time of film formation and voids are formed in a film layer by forcing this compound to foam during the drying process, a method in which a coating solution containing porous solid micro-particles and a hydrophilic binder on a support and voids are formed within porous micro-particles and among micro-particles, and a method in which a coating solution containing solid micro-particles or micro-oil-particles, having approximately same volume as or more volume than the hydrophilic binder, and a hydrophilic binder is coated on a support and voids are formed among the solid micro-particles. In a recording medium according to the present invention, a protective layer may be provided on an ink-absorbing layer as far as not disturbing the aimed effect of the present invention.

In the present invention, voids are preferably formed by incorporating various types of inorganic solid micro-particles having a mean particle diameter of not more than 100 nm in an ink-absorbing layer.

Inorganic micro-particles utilized for the above purpose include white pigments such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, silica, alumina, colloidal alumina, pseudo-boemite, aluminum hydroxide, lithopon, zeolite and magnesium hydroxide.

A mean particle diameter of inorganic micro-particles can be determined as a simple averaged value (number average) by observing particles themselves or particles appearing in the cross section or the surface of an ink-absorbing layer and measuring particle diameters of arbitrary 1000 particles. Herein, a particle diameter of each particle is a diameter of a supposed circle having the same projected area as the particle.

In the present invention, as inorganic particles, solid micro-particles, selected from silica, alumina or an alumina hydride, are preferably utilized.

As silica preferably utilized in the present invention, such as silica and colloidal silica synthesized by an ordinary wet method or silica synthesized by a gas phase method are preferable, however, colloidal silica or micro-particle silica synthesized by a gas phase method are specifically preferably utilized in the present invention; among them, micro-particle silica synthesized by a gas phase method is preferable because a high void ratio can be obtained as well as coarse aggregates are hardly formed when cationic polymer utilized for the purpose of fixing a dye is added. Further, as alumina or alumina hydride may be either crystalline or amorphous, and any form of such as irregular particles, spherical particles and needle-form particles can be utilized.

Inorganic micro-particles are preferably in a state that a micro-particles dispersion before being mixed with cationic polymer is dispersed to primary particles.

In the present invention, a water-soluble binder can be incorporated in an ink-absorbing layer. Water-soluble binders utilized in the present invention include, for example, polyvinyl alcohol, gelatin, polyethylene oxide, polyvinyl pyrrolidone, polyacrylic acid, polyacrylamide, polyurethane, dextrane, dextrine, colorgienan (such as κ,τ, λ), agar, pulullan, water-soluble polyvinyl butyral, hydroxyehtyl cellulose and carboxymethyl cellulose. These water soluble binders may be utilized in combination of at least two types.

A water-soluble binder preferably utilized in the present invention is polyvinyl alcohol.

Polyvinyl alcohol, preferably utilized in the present invention, includes also modified polyvinyl alcohol such as polyvinyl alcohol, the end of which is cationic modified, and anionic modified polyvinyl alcohol provided with an anionic group in addition to ordinary polyvinyl alcohol which is prepared by hydrolysis of polyvinyl acetate.

As polyvinyl alcohol prepared by hydrolysis of vinyl acetate, utilized are those having a mean polymerization degree of preferably not less than 1,000 and specifically preferably 1,500-5,000. Further, the saponification degree is preferably 70-100% and specifically preferably 80-99.5%.

Cationic modified polyvinyl alcohol includes, for example, polyvinyl alcohol provided with a primary-tertiary amino group or a quaternary ammonium group in the main chain or the side chain of the above-described polyvinyl alcohol, which are described in JP-A No. 61-10483, and can be prepared by saponification of a copolymer of an ethylenic unsaturated monomer provided with a cationic group and vinyl acetate.

Ethylenic unsaturated monomer having a cationic group includes such as trimethyl-(2-acrylamide-2,2-dimethylethyl) ammonium chloride, trimethyl-(3-acrylamide-3,3-dimethylpropyl) ammonium chloride, N-vinylimidazole, N-vinyl-2-methylimidazole, N-(3-dimethylaminopropyl)methacrylamide, hydroxylethyltrimethyl ammonium chloride, trimethyl-(2-methacrylamidepropyl) ammonium chloride and N-(1,1-dimethyl-3-dimethylaminopropyl) acrylamide.

The ratio of a monomer containing cationic modifying group in cationic modified polyvinyl alcohol is 0.1-10 mol % and preferably 0.2-5 mol % against vinyl acetate.

Anionic modified polyvinyl alcohol includes, for example, polyvinyl alcohol having an anionic group as described in JP-A No. 1-206088, a copolymer of vinyl alcohol and a vinyl compound having a water-soluble group as described in JP-A Nos. 61-237681 and 63-307979 and modified polyvinyl alcohol having a water-soluble group as described in JP-A No. 7-285265.

Further, nonionic modified polyvinyl alcohol includes, for example, polyvinyl alcohol derivatives, in which a polyalkylene oxide group is added to a part of vinyl alcohol, as described in JP-A No. 7-9758, and block copolymers of a vinyl compound having a hydrophobic group and vinyl alcohol as described in JP-A No. 8-25795. Polyvinyl alcohol may be utilized in combination of at least two types having different polymerization degrees or types.

The addition amount of inorganic micro-particles utilized in an ink-absorbing layer is very much dependent on an ink absorption volume, a void ratio of an ink-absorbing layer, a type of inorganic pigment and a type of a water-soluble binder, however, is generally 5-30 g and preferably 10-25 g, per 1 m² of a recording medium.

Further, the ratio of inorganic micro-particles to a water-soluble binder, which are utilized in an ink-absorbing layer, is generally 2:1-20:1 and specifically preferably 3:1-10:1.

Further, cationic water-soluble polymer provided with a quaternary ammonium group in the molecule may be contained in an ink-absorbing layer, and the addition amount is generally 0.1-10 g and preferably 0.2-5 g, per 1 m² of a recording medium.

In an ink-absorbing layer, the total amount of voids (void volume) is preferably not less than 20 ml/1 m² of a recording medium. When the void volume is less than 20 ml/m², the ink absorption property is good when ink quantity at printing is small, while, when ink quantity becomes large, ink cannot be completely absorbed often resulting in problems of deteriorated image quality and causing retardation in a drying property.

In an ink-absorbing layer provided with an ink retaining ability, a void volume against a solid volume is designated as a void ratio. In the present invention it is preferable to set a void ratio to not less than 50%, because void can be efficiently formed without making the layer thickness unnecessarily large.

In a recording medium of the present invention, a polymer compound, containing a hydrophilic polymer compound which is provided with a plural number of side chains in the main chain and has been irradiated with ionizing rays to make cross-linking bonds between side chains, is preferably incorporated as a hydrophilic binder with respect to further increasing the effects of the present invention.

In the present invention, a hydrophilic polymer compound provided with a plural number of side chains in the main chain is a polymer compound which forms cross-linking bonds between side chains by irradiation of ionizing radiation. And the main chain is constituted of at least one type selected from (a) a saponification product of polyvinyl acetate, (b)-polyvinyl acetal, (c) polyethylene oxide, (d) polyalkylene oxide, (e) polyvinyl pyrrolidone, (f) polyacrylamide, (g) hydroxyethyl cellulose, (h) methyl cellulose, (i) hydroxypropyl cellulose, (j) a derivative of at least one type of (a)-(i), and (k) a copolymer containing (a)-(j).

These hydrophilic polymer compounds are preferably resins which become hard to be dissolved in water after cross-linking by irradiation of ionizing radiation such as ultraviolet rays and electron rays.

Further, the side chain is preferably constituted of at least one modifying group selected from a photo-dimerization type, a photo-decomposition type, a photo-polymerization type, a photo-modification type. and a photo-depolymerization type, and is preferably prepared by modifying at least one type of main chain selected from above (a)-(k).

A hydrophilic polymer compound, provided with a plural number of side chains in the main chain, utilized in the present invention does not require such as a polymerization initiator and a polymerization inhibitor for cross-linking as well as can restrain generation of non-reacted free radials after irradiation of ionizing radiation, resulting in restrain deterioration of crack resistance on aging. Further, a network of a porous layer containing a binder containing a polymer compound, in which a hydrophilic polymer compound, provided with a plural number of side chains in the main chain, of the present invention is irradiated by ionizing radiation to form cross-links between side chains, contains a cross-link at a long distance to provide a structure easy to retain many inorganic micro-particles, resulting in uniform film formation with less amount of binder, that is, with a smaller ratio of binder to inorganic micro-particles, different from a three-dimensional structure at a relatively short distance such as a porous network formed only by employing cross-linking agent, and a porous network formed by irradiating ionizing radiation to a hydrophilic polymer compound without a plural number of side chains in the main chain or a hydrophilic polymer compound having a low polymerization degree.

In this manner, since the smaller is the binder ratio against inorganic micro-particles, the void ratio of an ink-absorbing layer increases to more easily retain ink (absorb ink), it is possible to prepare an inkjet recording medium provided with a porous layer which exhibits little cracking and peeling off of a recording layer before marking or printing after forming an inkjet recording medium, and strong resistance against stress by such as bending even after printing or marking, in addition to restrained ink overflow, rapid drying, strong coated film formation and strong bending resistance.

Therefore, prepared can be an inkjet recording medium exhibiting a high ink absorbability, improved moisture resistance, minimum crease and cracking, in addition to rapid ink drying rate.

Hydrophilic polymer compounds provided with a plural number of side chains in the main chain are preferably a diazo type of photo-dimerization type or those introduced with a cynamoyl group, a stylbazonium group or a stylquinolium group. Further, preferable is resin which can be dyed by a water-soluble dye such as an anionic dye after photo-cross-linking. Such resin, for example, includes resin provided with a cationic group such as a primary to quaternary ammonium group, for example, photosensitive resin (composition) described in such as JP-A Nos. 56-67309, 60-129742, 60-252341, 62-283339 and 1-198615; and resin provided with a group such as an azide group, which becomes an amino group and cationic by a curing process, for example, photosensitive resin (composition) described in JP-A 56-67.309.

Concretely, for example, preferable is a resin composition which is provided with 2-azide-5-nitrophenylcarbonyloxyethylene structure represented by following formula (I) 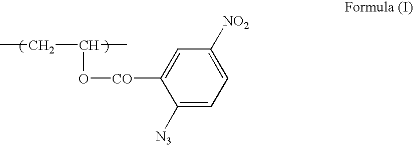
or 4-azide-3-nitrophenylcarbonyloxyethylene structure represented by following formula (II)

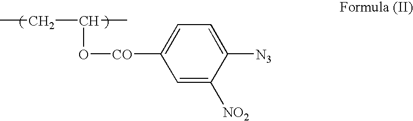

in a polyvinyl alcohol structure described in JP-A No. 56-67309.

Specific examples of the resin are described in examples 1 and 2 of said publication, and the constituting components of the resin and using ratio thereof are described in page 2 of said publication.

Further, photosensitive resin described in JP-A No. 60-129742 is polyvinyl alcohol type resin provided with a structure unit represented by the following formula (III) or (IV) in a polyvinyl alcohol structure. [Chemical Structure 3]

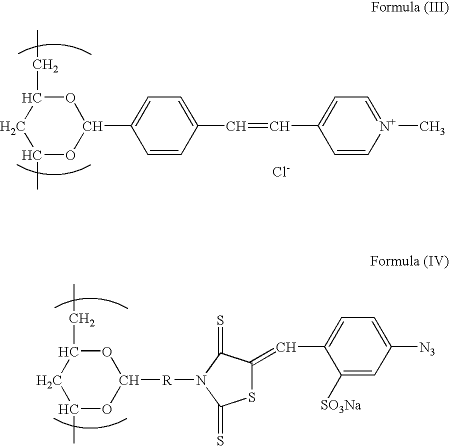

In the formulas, R₁ represents an alkyl group having a carbon number of 1-4 and A⁻ represents an anion. These are polyvinyl alcohol type resins provided with a structural unit having a stylylpyrridinium (stylubazorium) structure or a stylylquinolinium structure, which is prepared by reacting stylylpyrridinium salt or stylylquinorinium salt, having a formyl group, with polyvinyl alcohol or partly saponified polyvinyl acetate, and the manufacturing method is detailed in JP-A 60-129742 and can be easily manufactured referring thereto.

The ratio of a stylylpyrridinium group or a stylylquinolinium group in polyvinyl alcohol having a stylylpyrridinium group or a stylylquinolinium group is preferably 0.2-10.0 mol % per vinyl alcohol unit. Solubility into a coating solution can be improved by setting the ratio to not more than 10 mol %. Further, strength after cross-linking will be improved by setting the ratio to not less than 0.2 mol %.

Further, polyvinyl alcohol as a base in the above explanation may partly contain an un-saponified acetyl group and the content of an acetyl group is preferably less than 30%. And a polymerization degree thereof is preferably approximately 300-3000 and more preferably not less than 400. By setting the polymerization degree to not less than 300, irradiation time of radiation for a cross-linking reaction can be shortened resulting in improvement of productivity. Further, by setting the polymerization degree to not more than 3000, increase of viscosity can be restrained resulting in easy handling.

Herein, as a binder, utilized in combination may be a water-soluble resin such as gelatin, polyvinyl pyrrolidone, polyethylene oxide, polyacrylamide and polyvinyl alcohol together with the above-described hydrophilic polymer compound provided with a plural number of side chains in the main chain.

In the present invention, a photo-initiator or a photo-sensitizer is also preferably incorporated. These compounds may be dissolved or dispersed in a solvent, or may be chemically bonded to photosensitive resin.

A photo-initiator or a photo-sensitizer applied is not specifically limited, and those commonly known can be utilized.

A photo-initiator and photo-sensitizer utilized are not specifically limited, however, as an example, include benzophenones such as benzophenone, hydroxybenzophenone, bis-N,N-dimethylaminobenzophenone, bis-N,N-diethylaminobenzophenone, and 4-methoxy-4′-dimethylaminobenzophenone; thioxanthones such as thioxthantone, 2,4-diethylthioxthantone, isopropylthioxthantone, chlorothioxthantone and isopropoxychlorothioxthantone; anthraquinones such as ethylanthraquinone, benzanthraquinone, aminoanthraquinone and chloroanthraquinone; acetophenones; benzoinethers such as benzoinmethylether; 2,4,6-trihalomethyltriazines; 1-hydroxycyclohexyl phenyl ketone; 2,4,5-triarylimidazole dimmers such as a 2-(o-chlorophenyl)-4,5-diphenylimidazole dimer, a 2-(o-chlorophenyl)-4,5-di(m-methoxyphenyl)imidazole dimmer, a 2-(o-fluorophenyl)-4,5-diphenylimidazole dimer, a 2-(o-methoxyphenyl)-4,5-diphenyimidazole dimmer, a 2-(p-methoxyphenyl)-4,5-diphenyimidazole dimmer, a 2-di(p-methoxyphenyl)-5-phenyimidazole dimmer, a 2-(2,4-dimethoxyphenyl)-4,5-diphenyimidazole dimmer; benzyldimethy ketal, 2-benzyl-2-dimethylamino-1-(4-morphorinophenyl)-butane-1-one; 2-methyl-1-[4-(methylthio)phenyl]-2-morphorino-1-propanone; 2-hydroxy-2-mehyl-.1-phenyl-propane-1-one; 1-[4-(2-hydroxyethoxy)-phenyl]-2-hydroxy-2-methyl-1-propane-1-one; phenanthrenquinone; 9,10-phenanthrenequinone; benzoins such as methylbenzoin and ethylbenzoin; acrydine derivatives such as 9-phenylacrydine and 1,7-bis(9,9-acrydinyl)heptane; bisacylphosphine oxide; and mixtures thereof; which may be utilized alone or in combination.

Specifically, water-soluble initiators such as 1-[4-(2-hydroxyethoxy)-phenyl]-(2-hydroxy)-2-methyl-1-propane-1-one, 4-(2-hydroxyethoxy)-phenyl-(2-hydroxy-2-propyl)ketone, thioxthantone ammonium salt and benzophenone ammonium salt are preferable with respect to excellent miscibility as well as cross-linking efficiency. Further, in the case of utilizing ultraviolet rays as ionizing radiation, sensitizers such as thioxanthane, benzoin, benzoinalkyletherxanthone, dimehylxanthone, benzophnone, N,N,N′,N′-tetraethyl-4,4′-diaminobenzophenone and 1,1-dichloroacetophenone are preferable.

Herein, when a sensitizer is utilized, the using amount is preferably adjusted to approximately in a range of 0.2-10 weight % and preferably of 0.5-5 weight %, against ionizing radiation curable resin in a coating solution.

An accelerator may be added in addition to these initiators. Examples thereof include p-dimethylamino ethylbenzoate, p-dimethylamino isoamylbenzoate, ethanolamine, diethanolamine and triethanolamine. It may be blended at 0.05-3 weight % against ionizing radiation curable resin in a coating composition.

Further, polyvinyl alcohol, as a base in the above explanation, may partly contain an un-saponified acetyl group and the content of an acetyl group is preferably less than 30%. The saponification degree is preferably 70-100% and specifically preferably 90-100%.

Cationic polyvinyl alcohol is polyvinyl alcohol provided with a primary to tertiary amino group or a quaternary ammonium group in the main chain or side chain of said polyvinyl alcohol, and can be prepared by saponifying a copolymer of ethylenic unsaturated monomer, which has a cationic group, and vinyl acetate.

Ethylenic unsaturated monomers having a cationic group include such as trimethyl-(2-acrylamido-2,2-dimethylethyl)ammonium chloride, trimethyl-(3-acrylamido-3,3-dimethylpropyl) ammonium chloride, N-vinylimidazole, N-vinyl-2-methylimidazole, N-(3-dimethylaminopropyl)methacrylamide, hydroxyethyl-trimethylammonium chloride, trimethyl-(methacrylamidopropyl)ammonium chloride and N-(1,1-dimethyl-3-dimethylaminopropyl)acrylamide.

After coating a recording medium containing the above-described binder, the coated film is irradiated with ionizing radiation such as ultraviolet rays (a mercury lamp or a metal halide lamp). This irradiation of ionizing radiation causes a cross-linking reaction between side chains of a hydrophilic polymer compound to increase viscosity of a water-based coated film and prevent from being fluidized (so-called to be set), resulting in formation of an uniform coated film. After irradiation of ionizing radiation, the coated film is dried resulting in preparation of an inkjet recording medium containing a porous layer provided with voids which primarily contains a hydrophilic binder and micro-particles.

In the present invention, after irradiation of ionizing radiation, a coated layer is preferably dried to evaporate water-based solvents primarily containing water contained in the coated layer. Concretely, ionizing radiation is irradiated before an ink receiving layer after having been coated is pressing contacted to a heated mirror surface drum. Water-based solvents may be evaporated partly or mostly, however, coated film is preferably irradiated with ionizing radiation in a state of containing a hydrophilic solvent, and irradiation is more preferably performed immediately after the film having been coated. Thereby, since a porous layer can be formed by drying while the coated film is restrained from being fluidized due to cross-linking reaction between side chains of a hydrophilic polymer compound in the coated film, an inkjet recording medium containing an uniform porous layer can be prepared.

Ionizing radiation includes, for example, electron rays, ultraviolet rays, alpha rays, beta rays, gamma rays and X rays, and preferably utilized are electron rays and ultraviolet rays which exhibit little effect on a human body and easy handling as well as are prevailing in industrial applications.

In the case of employing electron rays as ionizing irradiation, the irradiation quantity of electron rays is preferably adjusted to approximately in a range of 0.1-20 Mrad. By setting to not less than 0.1 Mrad, a sufficient irradiation effect can be obtained, and by setting to not more than 20 Mrad, deterioration of a support, particularly such as paper or certain plastic, can be restrained. As an irradiation mode of electron rays, such as a scanning mode, a curtain beam mode and a broad beam mode are utilized, and an acceleration voltage at the time of irradiation of electron rays is preferably approximately 100-300 kV. Herein, an electron ray irradiation method exhibits, a higher productivity compared to ultraviolet ray irradiation, without no problem of odor and coloring due to addition of a sensitizer, in addition to advantage of providing a uniform cross-linking structure.

A hydrophilic polymer compound, which is provided with a plural number of side chains in the main chain and preferably utilized in the present invention, is capable of being sensitive to such as ultraviolet rays to perform cross-linking reaction without addition of such as the sensitizer described above, and such as an ultraviolet lamp (for example, a low-pressure, a medium-pressure and a high-pressure mercury lamps), a Xenon lamp, a tungsten lamp and a halogen lamp are utilized as a light source of ultraviolet rays, and ultraviolet rays having a strength of approximately 5000-8000 μW/cm² are preferably irradiated. Energy quantity required for curing is in a range of 0.02-20 kJ/cm².

A coating method to provide an interlayer or an ink-absorbing layer according to the present invention can be selected from commonly known methods. For example, utilized is a gravure coating method, a roll coating method, a rod-bar coating method, an air-knife coating method, a spray coating method, an extrusion coating method, a curtain coating method, or an extrusion coating method which utilizes a hopper described in U.S. Pat. No. 2,681,294.

At the time of forming an image by use of an inkjet recording medium of the present invention, inkjet ink can be utilized, and among them, preferably utilized is water-based dye ink containing such as a water-soluble dye, water and an organic solvent.

Water-soluble dyes utilized in the present invention include such as azo dyes, methine dyes, azomethine dyes, xanthene dyes, quinone dyes, phthalocyanine dyes, triphenylmethane dyes and diphenylmethane dyes, and specific examples thereof include, for example, dyes exemplified in JP-A No. 2002-264490.

Organic solvents utilized in the present invention are not specifically limited and are preferably water-soluble organic solvents which specifically include alcohols (such as methanol, ethanol, propanol, isopropanol, butanol, isobutanol, secondary butanol, tertiary butanol, pentanol, hexanol, cyclohexanol and benzyl alcohol), polyhydric alcohols (such as ethylene glycol, diethylene glycol, triethylene glycol, polyethylene glycol, propylene glycol, dipropylene glycol, polypropylene glycol, butylenes glycol, hexane diol, pentane diol, glycerin, hexane triol and thiodiglycol), polyhydric alcoholethers (ethylene glycol monomethylether, ethylene glycol monoethylether, ethylene glycol monobutylether, ethylene glycol monophenylether, diethylene glycol monomethylether, diethylene glycol monoethylether, diethylene glycol monobutylether, diethylene glycol dimethylether, propylene glycol monomethylether, propylene glycol monobutylether, ethylene glycol monomethylether acetate, triethylene glycol monomethylether, tiethylene glycol monoethylether, triethylene glycol monobutylether, triethylene glycol dimethylether, dipropylene glycol monopropylether and tripropylene glycol dimethylether), amines (such as ethanolamine, diethanolamine, triethanolamine, N-methyldiethanolamine, N-ethyldiethanolamine, morpholine, N-ethylmorpholine, ethylenediamine, triethylenetetramine, tetraethylene pentamine, polyethyleneimine, pentamethyldiethylenetriamine and tetramethylpropylenediamine), amides (such as formamide, N,N-dimethylformamide and N,N-dimethylacetoamide), heterocyclic rings (such as 2-pyrrolidone, N-methyl-2-pyrrolidone, N-cyclohexyl-2-pyrrolidone, 2-oxazolidone and 1,3-dimethyl-2-imidazolidine), sulfoxides (such as dimethylsulfoxide), sulfones (such as sulforane), sulfonates (such as sodium 1-butanesulfonate), urea, acetonitrile and acetone.

In ink according to the present invention, various types of surfactants can be utilized. Surfactants utilized in the present invention are not specifically limited and include, for example, anionic surfactants such as dialkylsulfo succinates, alkylnaphthalene sulfonates and fatty acid salts; nonionic surfactants such as polyoxyethylene alkylethers, polyoxyethylene alkylallylethers, acetylene glycols and polyoxyethylene polyoxypropylene blockcopolymers; and cationic surfactants such as alkylamines and quaternary ammonium salts. Particularly, anionic surfactants and nonionic surfactants are preferably utilized.

Further, in ink of the present invention, a polymer surfactant can be utilized. For example, listed are styrene-acrylic acid-alkylester acrylate copolymer, styrene-acrylic acid copolymer, styrene-maleic acid-alkylester acrylate copolymer, a styrene-maleic acid copolymer, styrene-methacrylic acid-alkylester acrylate copolymer, styrene-methacrylic acid copolymer, styrene-maleic acid half-ester copolymer, vinylnaphthalene-acrylic acid copolymer and vinylnaphthalene-maleic acid copolymer.

In ink according to the present invention, other than those explained above, well known various additives such as a viscosity controlling agent, a specific resistance controlling agent, a film forming agent, an ultraviolet absorbent, an anti-oxidant, an anti-fading agent, an anti-mold agent and anti-staining agent can be utilized by appropriate selection, depending on the purpose of improvement of ejection stability, adaptability to a print head and an ink cartridge, storage stability, an image lasting property and other various capabilities. For example, listed are oil micro-particles of such as fluid paraffin, dioctylphthalate, tricresylphosphate and silicone oil; ultraviolet absorbents described in JP-A Nos. 57-74193, 57-87988 and 62-261476; anti-fading agents described in JP-A Nos. 57-74192, 57-87989, 60-72785, 61-146591, 1-95091 and 3-13376; and fluorescent whitening agents described in JP-A Nos. 59-42993, 59-52689, 62-280069, 61-242871 and 4-219266.

### EXAMPLES

In the following, the present invention will be concretely explained referring to examples, however, is not limited thereto. Herein, “%” in examples represents weight % unless otherwise mentioned.

### Example 1

### <Preparation of Inkjet Recording Media>

[Preparation of Recording Medium 1]

(Preparation of Silica Dispersion D1)

Silica dispersion B1 (pH=2.3, containing 1 weight % of ethanol) of 400 L containing 25% of gas phase silica (Aerosil 200, manufactured by Nippon Aerosil Co., Ltd.), having a mean primary particle diameter of approximately 0.012 μm and uniformly dispersed in advance, and 0.3% of water-soluble fluorescent whitening agent UVITEXNFW LIQUID (manufactured by Ciba Specialty Chemicals Corp.), were added into 110 L of aqueous solution C1 (pH=2.5, containing 2 g of defoaming agent SN381, manufactured by Sunnopco Co., Ltd.) containing 12% of cationic polymer (P-1), 10% of n-propanol and 2% of ethanol, while stirring at 3000 rpm under room temperature. Next, into the resulting solution, 54 L of mixed aqueous solution Al (each 3 weight % concentration) of 1/1 (weight ratio) of boric acid and borax were gradually added while stirring.

Next, the solution was homogenized by use of a high-pressure homogenizer, manufactured by Sanwa Kogyo Co., Ltd., under a pressure. of 3 kN/cm² and the total volume was made up to 630 L with pure water, resulting in preparation of nearly transparent silica dispersion D1.

Above-described silica dispersion D1 was filtered by use of a TCP-30 type filter, manufactured. by Advantech Toyo Co., Ltd., having a filtering precision of 30 μm.

(Preparation of Silica Dispersion D2)

Above-described silica dispersion B1 of 400 L was added into 120 L of aqueous solution C2 (pH=2.5), containing 12% of cationic polymer (P-2), 10% of n-propanol and 2% of ethanol, while-stirring at 3000 rpm under room temperature, and then, into the resulting solution, 52 L of above-described mixed aqueous solution A1 were added while stirring.

Next, the solution was homogenized by use of a high-pressure homogenizer, manufactured by Sanwa Kogyo Co., Ltd., under a pressure of 3 kN/cm² and the total volume was made up to 630 L with pure water, resulting in preparation of nearly transparent silica dispersion D2.

Above-described silica dispersion D2 was filtered by use of a TCP-30 type filter, manufactured by Advantech Toyo Co., Ltd., having a filtering precision of 30 μm.

(Preparation of Oil Dispersion)

Diisodecylphthalate of 20 kg and 20 kg of an anti-oxidant (AO-1) were dissolved with heating in 45 kg of ethyl acetate, and after the resulting solution was mixed with a gelatin solution, containing 8 kg of acid processed gelatin, 2.9 kg of a cationic polymer (P-1) and 10.5 kg of saponin, to be emulsifying dispersed by use of a high-pressure homogenizer, and the total volume was made up to 300 L with pure water, resulting in preparation of an oil dispersion. 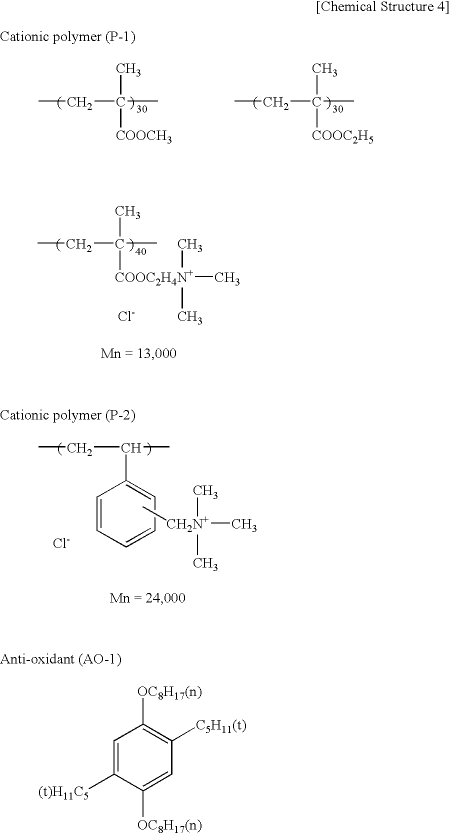
(Preparation of Ink-Absorbing Layer Coating Solution)

By utilizing each of dispersions prepared above, an ink-absorbing layer coating solution was prepared by successive addition of each additives described below.

| <The First Layer Coating Solution: Undermost Layer> | | |
|---|---|---|
| Silica dispersion D1 | 589 | ml |
| Polyvinyl alcohol (mean polymerization degree: 2300, | 290 | ml |
| saponification degree of 88%) 6.5% aqueous solution | | |
| Oil dispersion | 30 | ml |
| Latex dispersion (AE 803, manufactured by Showa Polymer | 42 | ml |
| Co., Ltd.) | | |
| Ethanol | 8.5 | ml |
| The total volume was made up to 1000 ml with pure water. | | |
| <The Second Layer Coating Solution> | | |
| Silica dispersion D1 | 548 | ml |
| Polyvinyl alcohol (mean polymerization degree: 2300, | 270 | ml |
| saponification degree of 88%) 6.5% aqueous solution | | |
| Oil dispersion | 20 | ml |
| Latex dispersion (AE 803, manufactured by Showa Polymer | 22 | ml |
| Co., Ltd.) | | |
| Ethanol | 8 | ml |
| The total volume was made up to 1000 ml with pure water. | | |
| <The Third Layer Coating Solution> | | |
| Silica dispersion D2 | 548 | ml |
| Polyvinyl alcohol (mean polymerization degree: 2300, | 135 | ml |
| saponification degree of 88%) 6.5% aqueous solution | | |
| Oil dispersion | 10 | ml |
| Latex dispersion (AE 803, manufactured by Showa Polymer | 5 | ml |
| Co., Ltd.) | | |
| Ethanol | 3 | ml |
| The total volume was made up to 1000 ml with pure water. | | |
| <The Forth Layer Coating Solution: Uppermost Layer> | | |
| Silica dispersion D2 | 548 | ml |
| Polyvinyl alcohol (mean polymerization degree: 2300, | 135 | ml |
| saponification degree of 88%) 6.5% aqueous solution | | |
| Betaine type surfactant-1 4% aqueous solution | 3 | ml |
| Saponin 25% aqueous solution | 2 | ml |

The total volume was made up to 1000 ml with pure water.

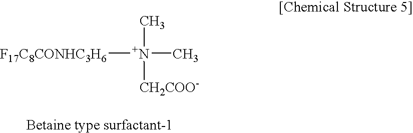

Each coating solution prepared in the above manner was filtered through a TCPD-30 filter, manufactured by Advantech Toyo Co., Ltd., having a filtering precision of 20 μm, followed by being filtered through a TCPD-10 filter.

[Preparation of Recording-Medium 101]

The coating solutions described above were four layer simultaneously coated at 40 °C. by use of a slide hopper type coater on a resin coated paper support, the both surfaces of which are covered with polyethylene, so as to make the following wet layer thickness. The first layer is a coating layer nearest to the support.

<Wet Film Thickness>

The first layer: 42 μm

The second layer: 39 μm

The third layer: 44 μm

The fourth layer: 38 μm

Herein, a resin coated paper support utilized above was contained of a photographic raw paper, having a moisture content of 8% and a basis weight of 170 g, the surface of which was coated with polyethylene containing 6% of anatase type titanium oxide at 35 μm thick by means of extrusion fusing and the back surface of which was coated with polyethylene at 40 μm thick by means of extrusion fusing. The front surface side was coated with polyvinyl alcohol (PVA 235, manufactured by Kuraray Co., Ltd.), after having been subjected to corona discharge, so as to make 0.05 g per 1 m² of the recording medium to form an under coat layer, and the back surface side, after having been subjected to corona discharge, was coated with a back layer containing approximately 0.4 g of a styrene-acrylic acid ester type latex binder having a Tg of approximately 80° C., 0.1 g of an anti-static agent (cationic polymer) and 0.1 g of silica of approximately 2 μm as a matting agent.

Herein, drying after an ink-absorbing layer coating solution had been coated was carried out by cooling the temperature of the film surface down to 13° C., followed by being dried by suitably setting the temperature of a plural number of drying zones, and the resulting product was wound in a roll form resulting in preparation of recording medium 101.

[Preparation of Recording Medium 102]

Recording medium 102 was prepared in the same manner as recording medium 101, except that wood free paper (Shiraoi having a basis weight of 157 g, manufactured by Nippon Daishowa Plate Paper Co., Ltd.) was utilized instead of a resin coated paper support.

[Preparation of Recording Medium 103]

Recording medium 103 was prepared in the same manner as recording medium 102, except that 5.0 g/m² in a solid amount of UWS-145 (urethane emulsion, produced by Sanyo Chemical Industry, Ltd.) was applied between a wood free paper support and an ink-absorbing layer as an interlayer.

[Preparation of Recording Medium 104]

Recording medium 104 was prepared in the same manner as recording medium 103, except that the same solid amount of LX473B (SBR emulsion, produced by Zeon Corp.) was employed instead of urethane emulsion UWS-145 as an interlayer.

[Preparation of Recording Medium 105]

Recording medium 105 was prepared in the same manner as recording medium 103, except that the same solid amount of HYDLITH 2019 (acryl emulsion, manufactured by Dainippon Ink and Chemicals Inc.) was employed instead of urethane emulsion UWS-145 as an-interlayer.

[Preparation of Recording Medium 106 to 108]

Each of recording media 106-108 was prepared in the same manner as each of recording media 103-105, respectively, except that wood free paper used for each support was replaced with art paper for printing (Art Post having a basis weight of 256 g, manufactured by Hokuetsu Paper Mfg. Co., Ltd.).

-[Preparation of Recording Media 109-111]

Each of recording media 109-111 was prepared in the same manner as each of recording media 103-105, respectively, except that wood free paper used for each support was replaced with cast coated paper for printing (Mirror Coat Satin Kanefuji having a basis weight of 209.3 g, manufactured by Oji Paper Mfg. Co., Ltd.).

[Preparation of Recording Medium 112]

Recording medium 112 was prepared in the same manner as recording medium 111, except that flatness of the cast coated paper for printing used for the support was increased by being subjected to a super-calender treatment under controlled pressure and temperature.

[Preparation of Recording Medium 113]

Recording medium 113 was prepared in the same manner as recording medium 111, except that a 10% aqueous solution of photo cross-linkable polyvinyl alcohol derivative containing a stilbazolium group (SPP: PVA having SHR main chain, polymerization degree: 2300, saponification degree: 88%, produced by Toyo Gosei Co., Ltd. ) was employed instead of the polyvinyl alcohol used for the coating solution of the ink-absorbing layer and that the boric acid/pyroborate solution was not added. Applied ink-absorbing layer was irradiated with 2 kJ/cm² of UV rays emitted from a metal halide lamp having a dominant wavelength of 365 nm, followed by drying at 80° C. in a hot-air oven.

<Evaluation of Each Characteristic>

[Measurement of Specular Glossiness of Support]

The surface glossiness of a support utilized in preparation of above each recording medium was measured by use of Variable Degree Glossiness Meter (VGS-1001DP), manufactured by Nippon Denshoku Industry Co., Ltd. at an incident and reflective degree of 60°.

[Measurement of C value of Support]

The image clarity (C value %) of a support utilized in preparation of above each recording medium was measured by use of Image Clarity Meter ICM-1DP (manufactured by Suga Test Machine Co., Lid.) at reflection of 60° and with a 2 mm optical comb.

[Measurement of Moisture Permeability]

In preparation of each recording medium described above, the moisture permeability under a condition of 40 °C.·90% RH was measured according to a method described in JIS Z 0208, with respect to a sample in a state of before coating of an ink-absorbing layer (support, or support/interlayer).

<Property Evaluation of Recording Media>

Recording media 101-113 prepared as described above were evaluated with respect to the following items.

[Gloss Feeling]

With respect to each recording medium, gloss feeling was visually observed after printing an image of such as a person or a landscape by use of PM-G 800, manufactured by Seiko-Epson Corp. Evaluation of gloss feeling was performed based on the following criteria.

A: Gloss feeling as same as that of silver salt photography,

B: Gloss feeling near to that of silver salt photography,

C: Gloss feeling inferior to that of silver salt photography,

D: Glossiness is clearly lower than that of silver salt photography.

[Evaluation of Ink Absorbability]

Each color solid image of black, yellow, magenta and cyan was printed on each recording medium, and plain paper was pressed onto the printed portion at 10 seconds after finishing the print to visually observe the degree of offset of ink. Evaluation of ink absorbability was performed based on the following criteria.

A: No offset of ink to plain paper is observed.

B: A slight offset of ink to plain paper is observed, which is not problematic in practice.

C: Some offset of ink to plain paper is observed.

D: Strong offset of ink to plain paper is generated.

[Evaluation of Bleeding Resistance at High Humidity]

Black letters are printed on solid image portions of red, green and blue by use of PM-G 800, manufactured by Seiko Epson Corp., on each recording medium, and a bleeding state of black letters was visually observed after each sample had been stored under an environment of 35° C.·80% RH for 3 days, to evaluate bleeding resistance under high humidity according to the following criteria.

A: No bleeding in each color is observed and letters are clearly readable.

B: Slight bleeding is generated in the case of complex letters; however, letters are readable.

C: The whole of letters become somewhat bold to produce bleeding, however, letters are readable.

D: Bleeding is significant and letters are unreadable.

[Evaluation of Crack Resistance]

Each recording medium, after having been rehumidified at 23° C. and a relative humidity of 20% for 24 hours, was wound up around cylindrical stainless steel bars having a diameter of 10, 20, 30, and 40 mm, respectively, to determine the diameter of stainless steel bar which causes cracks in an ink-absorbing layer. Crack resistance was evaluated based on the following criteria. Herein, the smaller is said value, the more flexible is an ink-absorbing layer.

A: Cracks are generated or no cracks at 10 mm.

B: Cracks are generated at 20 mm.

C: Cracks are generated at 30 mm.

D: Cracks are generated at 40 mm.

In the above evaluation, those generating cracks having not more than 20 mm are not problematic in practice; however, those generating cracks at 40 mm cause a problem such as cracking of a recording surface when a recording medium is rounded in such as a dry room.

The results of measurement and evaluation obtained above are shown in table 1.

TABLE 1

| | | | | | | | Bleeding | | | | |
|---|---|---|---|---|---|---|---|---|---|---|---|
| | | | | | Moisture | Ink | resist- | | | | |
| Re- | | | | Inter- | perme- | absorp- | ance | | | | |
| cording | Support | | | mediate | ability | tive | under | | Ink | Cracking | |
| medium | | C | Glossi- | layer | (g/m²/ | layer | high | Glossi- | absorb- | resist- | |
| No. | Materal | value | ness | binder | day) | binder | humidity | ness | ability | ance | Remarks |
| 101 | Resin | 62.0 | 28.0 | — | 35 | *1 | C | B | B | D | Com- |
| | coated | | | | | | | | | | parison |
| | paper | | | | | | | | | | |
| 102 | Wood | 50.1 | 3.5 | — | 15500 | *1 | B | D | A | B | Com- |
| | free | | | | | | | | | | parison |
| | paper | | | | | | | | | | |
| 103 | Wood | 50.1 | 3.5 | *1 | 5700 | *1 | B | D | B | B | Com- |
| | free | | | | | | | | | | parison |
| | paper | | | | | | | | | | |
| 104 | Wood | 50.1 | 3.5 | *2 | 4300 | *1 | C | D | A | B | Com- |
| | free | | | | | | | | | | parison |
| | paper | | | | | | | | | | |
| 105 | Art | 36.5 | 29.8 | — | 6500 | *1 | B | D | B | B | Com- |
| | Post | | | | | | | | | | parison |
| 106 | Art | 36.5 | 29.8 | *2 | 3700 | *1 | C | C | C | B | Com- |
| | Post | | | | | | | | | | parison |
| 107 | Art | 36.5 | 29.8 | *3 | 3400 | *1 | C | C | C | B | Com- |
| | Post | | | | | | | | | | parison |
| 108 | Miller | 65.8 | 77.6 | — | 9200 | *1 | B | C | B | D | Com- |
| | coat | | | | | | | | | | parison |
| 109 | Miller | 65.8 | 77.6 | *1 | 6200 | *1 | B | B | B | B | Inven- |
| | coat | | | | | | | | | | tion |
| 110 | Miller | 65.8 | 77.6 | *2 | 3500 | *1 | B | A | B | B | Inven- |
| | coat | | | | | | | | | | tion |
| 111 | Miller | 65.8 | 77.6 | *3 | 3300 | *1 | B | B | B | A | Inven- |
| | coat | | | | | | | | | | tion |
| 112 | Miller | 65.8 | 77.6 | *4 | 2900 | *5 | B | A | B | A | Invent- |
| | coat | | | | | | | | | | tion |
| 113 | Miller | 65.8 | 77.6 | *3 | 3100 | *5 | B | B | A | A | Inven- |
| | coat | | | | | | | | | | tion |

*1 Polyvinyl alcohol
*2 HYDLITH 2019
*3 UWS-145
*4 HYDLITH 2255R
*5 Photo cross-linkable polyvinyl alcohol

It is clear from table 1 that recording medium 101 which employed resin coated paper, which was an ordinary support for a glossy inkjet recording medium, showed inferior results in image bleeding under high humidity storage and crack resistance of a recording medium before printing. On the other hand, recording media 102-105, in which the support was replaced by wood free paper, showed significant decrease of glossy feeling irrespective of the presence of an interlayer; which indicates that smoothness and gloss of a support itself significantly affected glossy feeling of said recording media after coating of an ink-absorbing layer.

Further, in recording media 106-108, in which a support was changed to art paper for printing (Art Post), somewhat higher glossiness of a support compared to wood paper was observed, however, the C value was low and glossy feeling after printing was also proved to be not sufficient. From these results, it is clear that a high gloss recording medium requires compatibility of glossiness of a support and a high C value.

In any of recording media 109-111, in which a support was changed to cast coated paper and the interlayer contains water-dispersible polymer, high glossy feeling after printing was observed and also compatibility with other capabilities have been achieved. Among these, recording medium 111 containing acryl emulsion in the interlayer exhibits high gloss feeling which was comparable with that of silver salt photography.

In recording medium 112 in which the flatness of the support was further increased by applying a super-calendar treatment to the cast coated paper for printing, high gloss feeling was surely obtained, however, the flatness was too high resulting in giving unnatural glare.

In recording medium 113 in which the binder used in recording medium 111 was replaced with a photo cross-linkable polyvinyl alcohol, gloss feeling, ink absorbability, resistance for cracking were further increased.

### Example 2

### <<Preparation of Inkjet Recording Media>>

[Preparation of Recording Medium 201]

Recording medium 201 was prepared in the same manner as recording medium 101 except that the ratio of the solid amount of polyethylene applied on the front surface to that of polyethylene applied on the back surface was changed to 0.3:1, while that of polyethylene applied on the back surface was unchanged.

[Preparation of Recording Medium 202]

Wood free paper (Shiraoi having a basis weight of 157 g, manufactured by Nippon Daishowa Plate Paper Co., Ltd.) was used as the support. Polyvinyl alcohol (PVA235, manufactured by Kuraray Co., Ltd.) was applied on both surfaces of the support with a solid amount of 10 g/m² (ratio of solid amount of polyvinyl alcohol applied to form the intermediate layer to that applied on the back surface of the support was 1:1) .

Recording medium 202 was prepared by applying an ink-absorbing layer made up of 4 layers on thus obtained interlayer.

[Preparation of Recording Medium 203]

Recording medium 203 was prepared in the same manner as recording medium 202 except that the polyvinyl alcohol used for the interlayer and the back layer was replaced with the same solid amount of UWS-145 (urethane emulsion, produced by Sanyo Chemical Industry, Ltd.).

[Preparation of Recording Medium 204]

Recording medium 204 was prepared in the same manner as recording medium 202 except that the polyvinyl alcohol used for the interlayer and the back layer was replaced with the same solid amount of LX473B (SBR emulsion, produced by Zeon Corp.).

[Preparation of Recording Medium 205]

Recording medium 205 was prepared in the same manner as recording medium 202 except that the polyvinyl alcohol used for the interlayer and the back layer was replaced with the same solid amount of HYDLITH 2019 (acryl emulsion, manufactured by Dainippon Ink and Chemicals Inc.).

[Preparation of Recording Medium 206]

Recording medium 206 was prepared in the same manner as recording medium 205 except that the ratio of the solid amount of the resin applied to form the intermediate layer to that of the resin applied on the back surface was changed to 0.3:1, while that of the resin applied on the back surface was unchabged.

[Preparation of Recording Media 207-210]

Each of recording media 207-210 was prepared in the same manner as each of recording media 202-205, respectively, except that wood free paper used for each support was replaced with art paper for printing (Art Post having a basis weight of 256 g, manufactured by Hokuetsu Paper Mfg. Co., Ltd.).

[Preparation of Recording Media 211-214]

Each of recording media 211-214 was prepared in the same manner as each of recording media 202-205, respectively, except that wood free paper used for each support was replaced with cast coated paper for printing (Mirror Coat Satin Kanefuji having a basis weight of 209.3 g, manufactured by Oji Paper Mfg. Co., Ltd.).

[Preparation of Recording Medium 215]

Recording medium 215 was prepared in the same manner as recording medium 214 except that the weight ratio of the solid portion of the resin applied to form the interlayer to that of the resin applied on the back surface was changed to 0.3:1, while that of the resin applied on the back surface was unchanged.

[Preparation of Recording Medium 216]

Recording medium 216 was prepared in the same manner as recording medium 215 except that the resin used for the back layer was replaced with the same solid amount of UWS-145 (urethane emulsion, produced by Sanyo Chemical Industry, Ltd.).

[Preparation of Recording Medium 217]

Recording medium 217 was prepared in the same manner as recording medium 215, except that a 10% aqueous solution of photo cross-linkable polyvinyl alcohol derivative containing a stilbazolium group (SPP: PVA having SHR main chain, polymerization degree: 2300, saponification degree: 88%, produced by Toyo Gosei Co., Ltd.) was employed instead of the polyvinyl alcohol used for the coating solution of the ink-absorbing layer and that the boric acid/pyroborate solution was not added. Applied ink-absorbing layer was irradiated with 2 kJ/cm² of UV rays emitted from a metal halide lamp having a dominant wavelength of 365 nm, followed by drying at 80° C. in a hot-air oven.

[Preparation of Recording Medium 218]

Recording medium 218 was prepared in the same manner as recording medium 215 except that the coating solution for the ink-absorbing layer was replaced with an coating solution for a swellable ink-absorbing layer having the following composition.

(Preparation of Swellable Ink-absorbing Layer coating Solution and Coating)

40 g of phenylcarbamoyl gelatin, 25 g of polyvinylpyrrolidone (molecular weight: 360,000), 12 g of polyethyleneoxide (molecular weight: 10.0,000), 1 g of surfactant (emulgen 120, Kao Corp.) and 2.1 g of tetrakis (vinylsulfonylmethyl)methane were dissolved and stirred in 800 g of pure water to prepare a swellable ink-absorbing layer coating solution.

Thus prepared coating solution was coated on a cast coated paper for printing having thereon an interlayer with a swelled thickness of 150 μm using a slide hopper and dried using hot-air of which temperature was changed in stages, followed by leaving the product for 12 hours under a condition of 40° C. and 80%RH to obtain recording medium 218.

<Measurements of Various Properties on Support and Support Provided with Interlayer and Resin Layer on Back Surface>

The following measurements were carried out on each having an interlayer and a resin layer on the back surface of recording media 101 and 201-218.

[Measurement of Surface Roughness on Support and Support Provided with Interlayer and Resin Layer on Back Surface]

Surface roughness (μm) was measured using HANDYSURF E-35A at a cut-off value of 0.8 mm with a standard length of 4 mm on the supports and the supports each having an interlayer and a resin layer on the back surface used for the above recording media.

[Measurement of Moisture permeability on Support and Support Provided with Interlayer and Resin Layer on Back Surface]

Moisture permeability (g/m²/day) was measured according to the method described in JIS Z 0208 under a condition of 40° C. and 90% RH on the supports and the supports each having an interlayer and a resin layer on the back surface used for the above recording media.

The construction of each recording medium and results of measurements were summarized in Table 2.

TABLE 2

| | | | Moisture | | | | | | |
|---|---|---|---|---|---|---|---|---|---|
| | | | permea- | | | | | | |
| | | | bility | | Ratio of | | Ra of | | |
| | | | before | Applied | applied | | sup- | | |
| | | Ra | providing | resin of | resin of | | port + | Binder of | |
| | | of | inter- | intermediate | intermediate | Moisture | inter- | ink ab- | |
| Sam- | | sup- | mediate | layer/back | layer/back | permea- | mediate | sorbing | Re- |
| ple | Support | port | layer | surface | surface | bility | layer | layer | marks |
| 101 | Resin coated paper | 0.1 | 5500 | None/PE | — | 30 | 0.1 | PVA | Comp. |
| 201 | Resin coated Paper | 0.1 | 5500 | PE | 0.3:1 | 30 | 0.1 | PVA | Comp. |
| 202 | Wood free paper | 1.9 | 15500 | Polyvinyl alcohol (PVA) | 1:1 | 10000 | 1.4 | PVA | Comp. |
| 203 | Wood free paper | 1.9 | 15500 | UWS-145 | 1:1 | 8800 | 1.3 | PVA | Comp. |
| 204 | Wood free paper | 1.9 | 15500 | LX473B | 1:1 | 8200 | 1.3 | PVA | Comp. |
| 205 | Wood free paper | 1.9 | 15500 | HYDLITH2019 | 1:1 | 4000 | 1.1 | PVA | Comp. |
| 206 | Wood free paper | 1.9 | 15500 | HYDLITH2019 | 0.3:1 | 3800 | 1.1 | PVA | Comp. |
| 207 | Art Paper | 0.35 | 7800 | Polyvinyl alcohol (PVA) | 1:1 | 4400 | 0.45 | PVA | Comp. |
| 208 | Art Paper | 0.35 | 7800 | UWS-145 | 1:1 | 2500 | 0.51 | PVA | Comp. |
| 209 | Art Paper | 0.35 | 7800 | LX473B | 1:1 | 2500 | 0.38 | PVA | Comp. |
| 210 | Art Paper | 0.35 | 7800 | HYDLITH2019 | 1:1 | 2900 | 0.36 | PVA | Comp. |
| 211 | Cast-coated paper | 0.12 | 9200 | Polyvinyl alcohol (PVA) | 1:1 | 2900 | 0.14 | PVA | Inv. |
| 212 | Cast-coated paper | 0.12 | 9200 | UWS-145 | 1:1 | 2900 | 0.14 | PVA | Inv. |
| 213 | Cast-coated paper | 0.12 | 9200 | LX473B | 1:1 | 2700 | 0.12 | PVA | Inv. |
| 214 | Cast-coated paper | 0.12 | 9200 | HYDLITH2019 | 1:1 | 2800 | 0.13 | PVA | Comp. |
| 215 | Cast-coated paper | 0.12 | 9200 | HYDLITH2019 | 0.3:1 | 2800 | 0.12 | PVA | Inv. |
| 216 | Cast-coated paper | 0.12 | 9200 | HYDLITH2019/UWS-145 | 0.3:1 | 4400 | 0.12 | PVA | Inv. |
| 217 | Cast-coated paper | 0.12 | 9200 | HYDLITH2019 | 0.3:1 | 2800 | 0.12 | Photo | Inv. |
| | | | | | | | | cross- | |
| | | | | | | | | linkable | |
| | | | | | | | | PVA | |
| 218 | Cast-coated paper | 0.12 | 9200 | HYDLITH2019 | 0.3:1 | 2800 | 0.12 | Absorbing | Inv. |
| | | | | | | | | layer: | |
| | | | | | | | | Gelatin | |

Comp. Comparative sample,
Inv. Inventive sample

<Property Evaluations of Recording Media>

Property evaluations were carried out on above prepared recording media 101 and 201-218.

[Evaluation of Gloss Feeling]

Human images or landscape images were printed using an inkjet printer PM-G800 produced by SEIKO EPSON Corp. on each recording medium and glossiness was evaluated by eye observation. Evaluation was carried out according to the following criteria.
A: Gloss feeling is comparative to that of a silver-salt photograph.
B: Gloss feeling is close to that of a silver-salt photograph.
C: Gloss feeling is inferior to that of a silver-salt photograph.
D: Gloss feeling is notably inferior to that of a silver-salt photograph.
   [Evaluation of Paper Tracking]

Each recording medium was cut into “L” size sheets, 50 sheets of which were piled and mounted on an inkjet printer PM-G800 produced by SEIKO EPSON Corp. Then, the same image was continuously printed and the number of sheets which were not printed was counted, because of double feeding of two or more sheets. Evaluation was carried out according to the following criteria.
A: Number of double feeding is 0 or 1.
B: Number of double feeding is 2-4.
C: Number of double feeding is 5-10.
D: Number of double feeding is 11 or more.
   [Evaluation of Curl Before Printing]

Each recording medium was cut into 10 cm square sheets and each sheet was placed with the ink-absorbing layer side surface up so as not to overlap with each other, followed by being left for 24 hours under a condition of 23° C. and 20% RH. The sheets were then left for another 24 hours under a condition of 23° C. and 80% RH. Heights of the four corners of each resulting curled sheet was measured where the height of the corner of a sheet curling toward the ink-absorbing layer side surface was designated as “plus” and that of the sheet curling toward the opposite direction was designated as “minus”. An average value of the heights (absolute value) were determined and evaluated according to the following criteria.
A: The absolute average value of the curl is less than 2 mm.
B: The absolute average value of the curl is not less than 2 mm and less than 5 mm.
C: The absolute average value of the curl is not less than 5 mm and less than 8 mm.
D: The absolute average value of the curl is 8 mm or more.
   [Evaluation of Curl Aefore Printing]

On each recording medium, a landscape image was printed under a condition of 23° C. and 55% RH. After printing, each recording medium was placed with the printed image side surface up so as not to overlap with each other and left for 24 hours under the same condition of 23° C. and 55% RH as the printing condition. The absolute average value of each sheet was determined in the same manner as the absolute average value for the recording media before printing and evaluated according to the following criteria.
A: The absolute average value of the curl is less than 2 mm.
B: The absolute average value of the curl is not less than 2 mm and less than 5 mm.
C: The absolute average value of the curl is not less than 5 mm and less than 8 mm.
D: The absolute average value of the curl is 8 mm or more.
   [Evaluation of Bleeding Resistance at High Humidity]

Black letters are printed on solid image portions of red, green and blue by use of PM-G 800, manufactured by Seiko Epson Corp., on each recording medium, and a bleeding state of black letters was visually observed after each sample had been stored under an environment of 35° C.-80% RH for 3 days, to evaluate bleeding resistance under high humidity according to the following criteria.
A: No bleeding in each color is observed and letters are clearly readable.
B: A little bleeding is generated in the case of complex letters; however, letters are readable.
C: The whole of letters become somewhat bold to produce bleeding, however, letters are readable.
D: Bleeding is notable and letters are unreadable.

Results obtained as above were shown in FIG. 3.

TABLE 3

| | | Easiness | Curl | Curl | | |
|---|---|---|---|---|---|---|
| Sam- | Glossi- | of | before | after | | |
| ple | ness | conveyance | printing | printing | Bleeding | Remarks |
| 101 | B | C | B | B | D | Comp. |
| 201 | C | C | C | C | D | Comp. |
| 202 | D | D | D | D | C | Comp. |
| 203 | D | D | D | D | B | Comp. |
| 204 | D | D | D | D | B | Comp. |
| 205 | D | D | D | D | B | Comp. |
| 206 | D | C | C | C | C | Comp. |
| 207 | C | C | D | D | D | Comp. |
| 208 | C | C | C | C | D | Comp. |
| 209 | C | D | C | C | C | Comp. |
| 210 | C | C | D | C | C | Comp. |
| 211 | C | C | D | D | B | Inv. |
| 212 | B | B | B | B | B | Inv. |
| 213 | B | B | B | B | B | Inv. |
| 214 | B | A | B | B | B | Comp. |
| 215 | B | A | A | A | B | Inv. |
| 216 | B | B | B | A | B | Inv. |
| 217 | A | A | A | A | A | Inv. |
| 218 | A | B | A | B | B | Inv. |

Inv. Inventive Sample,
Comp. Comparative Sample

As shown in table 3, recording medium 101 in which resin coated paper was used was satisfactory in glossiness and curl, however, it showed a problem in bleeding. Recording medium 201 also had a problem in bleeding. Too low moisture permeability would have resulted in the problem in bleeding.

Recording medium 202 in which wood free paper was used as the support showed lower glossiness because the flatness of the support was not enough. It was also supposed to be because wood free paper was more difficult to increase the flatness. Also, curl of recording medium 202 easily occurred because polyvinyl alcohol used in the interlayer was dissolved by the water contained in the coating solution of the ink-absorbing layer, resulting in increase of moisture permeability to the surface of the support.

In recording media 203-205, materials used for the interlayer and the resin layer on the back surface were changed while the same support was used, however, no obvious improvement in properties was observed. In recording medium 206, the weight ratio of a solid portion contained in the interlayer to a solid portion contained in the resin layer on the back surface was changed, however, only a small improvement in properties was observed.

In recording media 207-210, the support was changed to art paper for printing, however, the observed improvement was not large.

In recording medium 211, cast coated paper for printing was used for the support and polyvinyl alcohol was used for both the interlayer and the resin layer on the back surface. The surface roughness of the interlayer decreased to below 0.20 μm, however, the gloss feeling decreased and the improvement in paper tracking, curl property and bleeding was not satisfactory. This was supposed to be because, when polyvinyl alcohol was used in the interlayer, water contained in the coating solution permeated through the support.

In recording media 212-218 of the present invention, cast coated paper for printing was used for each support, a water dispersive polymer was used for each interlayer and each resin layer on the back surface, the moisture permeability of each support provided with the interlayer was not less than 100 g/m²/day and not more than 5000 g/m²/day, the surface roughness Ra of the surface of each support where the interlayer was provided was not less than 0.05 μm and not more than 0.20 μm. These recording media exhibited excellent properties of all the items, namely, gloss feeling, paper tracking, prevention of curl before printing, prevention of curl after printing and bleeding resistance at high humidity, compared to those of the comparative samples.

Among recording media 212-218, recording medium 215 exhibited further improved anti-curling property, in which the weight ratio of a solid portion contained in the interlayer to a solid portion contained in the resin layer was changed to 0.3:1.

The recording medium prepared in the same manner as recording medium 215 except that photo cross-linkable poly vinyl alcohol was used as a binder of the ink-absorbing layer also showed highly improved properties in all of the above items.

In recording medium 218, a swellable ink-absorbing layer was employed by using gelatin in the ink-absorbing layer, excellent properties were obtained in all the above items, although slightly inferior to those of recording media 215 and 217.

### Example 3

[Preparation of Recording Medium 301]

Recording medium 301 was prepared in the same manner as recording medium 215 of EXAMPLE 2 except that Surfynol 465 (Surfactant based on acetylene glycol, produced by Nissin Chemical industry Co., Ltd.) was added in both coating solutions for the interlayer and the resin layer on the back surface so that the amount of surfynol coated on both surfaces was 0.1 g/m².

[Preparation of Recording Medium 302]

Recording medium 302 was prepared in the same manner as recording medium 301 except that an antifoam agent (SH5507, produced by Dow Corning Toray Co., Ltd.) was added in both coating solutions for the interlayer and the resin layer on the back surface so that the amount of surfynol coated on both surfaces was 0.1 g/m².

[Preparation of Recording Medium 303]

Recording medium 303 was prepared in the same manner as recording medium 302 except that 2,2,4-trimethyl-1,3-pentanediol monoisobutylate was added as a film forming auxiliary agent in both coating solutions for the interlayer and the resin layer on the back surface so that the solid content was 5.0 wt % based on the amount of HYDLITH 2019 (acryl emulsion, manufactured by Dainippon Ink and Chemicals Inc.).

[Preparation of Recording Medium 304]

Recording medium 304 was prepared in the same manner as recording medium 303 except that polyvinyl alcohol (PVA 235, manufactured by Kuraray Co., Ltd.) was coated on the inter layer to form an additional layer before coating the ink-absorbing layer so that the amount of coated polyvinyl alcohol was 0.05 g/m².

[Preparation of Recording Medium 305]

Recording medium 305 was prepared in the same manner as recording medium 304 except that the surface of the additional layer was modified by being subjected to a corona discharge treatment (applied voltage: 50 kV, distance between electrode-sample: 20 mm) before coating an ink-absorbing layer.

<Evaluation of Recording Media>

The following evaluations were carried out on above described recording media 301-305 and recording medium 215 prepared in EXAMPLE 2.

[Evaluation of Prevention of Coating Fault]

Numbers of occurrences of shedding, floating and swelling on the ink-absorbing layer side surface per 1 m² was observed by using a magnifying lens

[Evaluation of Curl Before-Printing]

Each recording medium was cut into 10 cm square sheets and each sheet was placed with the ink-absorbing layer side surface up so as not to overlap with each other, followed by being left for 24 hours under a condition of 23° C. and 20% RH. The sheets were then left for another 24 hours under a condition of 23° C. and 80% RH. Heights of the four corners of each resulting curled sheet was measured where the height of the corner of a sheet curling toward the ink-absorbing layer side surface was designated as “plus” and that of the sheet curling toward the opposite direction was designated as “minus”. An average value of the heights (absolute value) were determined and evaluated according to the following criteria.
A: The absolute average value of the curl is less than 2 mm.
B: The absolute average value of the curl is not less than 2 mm and less than 5 mm.
C: The absolute average value of the curl is not less than 5 mm and less than 8 mm.
D: The absolute average value of the curl is 8 mm or more.

The results were shown in Table 4.

TABLE 4

| | | | | | Modifying | | |
|---|---|---|---|---|---|---|---|
| | | | | | before | Number of | |
| | | Anti- | Film | Addi- | ink | printing | Curl |
| | Sam- | foaming | forming | tional | absorbing | fault | before |
| | ple | agent | agent | layer | layer | points/m² | printing |
| 215 | Non | Non | Non | Non | Non | 15 | B |
| 301 | App. | Non | Non | Non | Non | 10 | B |
| 302 | App. | App. | Non | Non | Non | 7 | B |
| 303 | App. | App. | App. | Non | Non | 5 | A |
| 304 | App. | App. | App. | App. | Non | 2 | A |
| 305 | App. | App. | App. | App. | App. | 0 | A |

App. Applied

As shown in FIG. 4, the number of coating fault was decreased and, further increased anti-curling property was obtained even undeer severe conditions by the following procedures:(i) adding a surfactant or a film-forming auxiliary agent to coating solutions for the interlayer and the resin layer on the back surface; (ii) providing an additional layer between the interlayer and the ink-absorbing layer; and (iii) modifying the surface of the additional layer.

What is claimed is:

1. An inkjet recording medium comprising a support having thereon an interlayer and an ink-absorbing layer in that order, wherein:
a C value of the support is not less than 50, the C value being a scale of image clarity;
a 60° specular glossiness of the support is not less than 20%; and
a moisture permeability of the support after the interlayer is provided is not less than 100 g/m²/day and not more than 5000 g/m²/day.

2. The inkjet recording medium of claim 1, wherein a surface roughness of the support provided with the interlayer is not less than 0.05 μm and not more than 0.2 μm, measured at a cut-off value of 0.8 mm with a standard length of 4 mm.

3. The inkjet recording medium of claim 1, wherein a moisture permeability of the support is not less than 7000 g/m²./day and not more than 12000 g/m²/day.

4. The inkjet recording.medium of claim 1, wherein the support comprises a cast-coated paper.

5. The inkjet recording medium of claim 1, wherein the interlayer contains an acryl resin emulsion.

6. The inkjet recording medium of claim 1, wherein the ink-absorbing layer contains inorganic microparticles and a hydrophilic binder.

7. The inkjet recording medium of claim 6, wherein the hydrophilic binder contains a polymer prepared by irradiating a hydrophilic polymer containing a main chain and a plurality of side chains with ionizing radiation so as to form cross-linking bonds between the side chains.

8. An inkjet recording medium comprising a support having thereon an interlayer and an ink-absorbing layer in that order on one surface of the support and having a resin layer on the other surface of the support opposite the interlayer, wherein
a moisture permeability of the support provided with the interlayer and the resin layer is not less than 100 g/m²/day and not more than 5000 g/m²/day; and
a surface roughness Ra of a surface of the support provided with the interlayer is not less than 0.05 μm and not more than 0.20 μm, measured at a cut-off value of 0.8 mm with a standard length of 4 mm.

9. The inkjet recording medium of claim 8, wherein
the support comprises a cast-coated paper; and
the interlayer and the resin layer are waterproof layers.

10. The inkjet recording medium of claim 9, wherein the interlayer and the resin layer are waterproof layers having substantially the same composition; and
a weight ratio of a solid portion contained in the interlayer to a solid portion contained in the resin layer is in the range of 0.05:1 to 0.50:1.

11. The inkjet recording medium of claim 10, wherein
the interlayer or the resin layer contains an acryl resin as a main component.

12. The inkjet recording medium of claim 10, wherein
the interlayer or the resin layer contains a surfactant.

13. The inkjet recording medium of claim 10, wherein
the interlayer or the resin layer contains an antifoam agent.

14. The inkjet recording medium of claim 10, wherein
the interlayer or the resin layer contains a film-forming auxiliary agent.

15. The inkjet recording medium of claim 10, wherein
an additional layer is provided between the interlayer and the ink-absorbing layer.

16. A method for producing the inkjet recording medium of claim 1 comprising the steps of:
providing the interlayer on the support;
modifying a surface of the interlayer; and
providing the ink-absorbing layer on the modified interlayer.

17. A method for producing the inkjet recording medium of claim 8 comprising the steps of:
providing the interlayer on the support;
modifying the surface of the interlayer; and
providing the ink-absorbing layer on the modified interlayer.

18. The method of claim 16, wherein the step of modifying the surface of the interlayer and the step of providing the ink-absorbing layer are carried out in an on-line system.

19. The method in claim 17, wherein the step of modifying the surface of the interlayer and the step of providing the ink-absorbing layer are carried out in an on-line system.
